(19) United States
(12) Patent Application Publication
(10) Pub. No.: US 2020/0149124 A1
(43) Pub. Date: May 14, 2020

(54) METHOD FOR OPERATING AN IRON- OR STEELMAKING- PLANT

(71) Applicant: L'Air Liquide, Société Anonyme pour l'Etude et l'Exploitation des Procédés Georges Claude, Paris (FR)

(72) Inventors: Philippe BLOSTEIN, Paris (FR); Mike GRANT, Bad Homburg (DE)

(21) Appl. No.: 16/628,171

(22) PCT Filed: Jul. 2, 2018
(86) PCT No.: PCT/EP2018/067820

§ 371 Date: Jan. 2, 2020

(30) Foreign Application Priority Data
Jul. 3, 2017 (EP) 17305860.3

(51) Int. Cl. C21B 5/06; F27B 1/10; F27D 7/02; F27B 1/16

(52) U.S. Cl. CPC C21B 5/06; F27B 1/10; C21B 2100/40; F27B 1/16; F27D 7/02

(57) ABSTRACT

A method of operating an ironmaking or steelmaking plant with low CO₂-emissions is provided. Hydrogen and oxygen are generated by water decomposition and at least part of the generated hydrogen is injected as a reducing gas into one or more ironmaking furnaces with off-gas decarbonation and reinjection into the furnaces of at least a significant part of the decarbonated off-gas and at least part of the generated oxygen is injected as an oxidizing gas in the one or more ironmaking.

### CROSS REFERENCE TO RELATED APPLICATIONS

This application is a 371 of International PCT Application No. PCT/EP2018/067820, filed Jul. 2, 2018, which claims priority to European Patent Application No. 17305860, filed Jul. 3, 2017, the entire contents of which are incorporated herein by reference.

### BACKGROUND

The present invention relates to the production of iron or steel in an iron- or steelmaking plant in which iron is produced from iron ore.

There are currently two paths to making iron from iron ore:
the production of molten iron from iron ore in a blast furnace (BF) charged with iron ore and coke and into which combustible matter, such as coal, may also be injected as fuel and reducing agent; and
the production of sponge iron or direct reduced iron (DRI) in a so-called direct reduction process whereby iron oxides in the iron ore are reduced in the solid state without melting.

Liquid or solidified iron from blast furnaces (known as “pig iron”) contains high levels of carbon. When pig iron is used to produce steel, it must be partially decarburized and refined, for example in a converter, in particular in a Linz-Donawitz Converter (in short L-D converter) also known in the art as a basic oxygen furnace (BOF).

In the absence of special measures during the direct reduction process, DRI contains little or no carbon. In order to produce steel from DRI, the DRI is melted in a smelter or electric arc furnace (EAF) and additives are added to the melt so as to obtain steel with the required composition.

The production of iron in blast furnaces remains by far the most important method of producing iron from iron ore and iron produced in blast furnaces remains the main iron source for steel production.

The iron and steel industry accounts for a significant percentage of the world's CO₂ emissions.

Significant efforts have been made to reduce these emissions and therefore the “carbon footprint” of the iron and steel industry.

It has, for example, been suggested to inject hydrogen as a reducing in iron ore reduction furnaces.

For example, in WO-A-2011/116141 it has been proposed to produce sponge iron from iron ore by means of hydrogen in a two-step reduction process:

3Fe₂O₃+H₂→2Fe₃O₄+H₂O and

Fe₃O₄+4H₂→3Fe+4H₂O.

Heat is supplied to the iron ore direct reduction furnace according to WO-A-2011/116141 by means of a separate oxy-hydrogen flame generator which operates at an H₂:O₂ ratio between about 1:1 and 5:1 and at a temperature of less than about 2800° C. Said direct reduction furnace is described as producing steam as a by-product and not generating any CO₂ emissions.

No further details are provided in WO-A-2011/116141 regarding the structure or operation of said direct reduction furnace and to date the proposed technology has not been industrially exploited.

There have likewise been many proposals to inject hydrogen into blast furnaces, alone or in combination with other reducing gases, as a complementary reducing agent in addition to coke.

Various attempts in industrial iron- or steelmaking installations with different earlier described technologies involving hydrogen injection in blast furnaces have failed either to achieve a significant coke or other hydrocarbon fuel consumption at constant melt rates of the blast furnace or to achieve a significant increase in production at constant coke/hydrocarbon load. For this reason, the injection of hydrogen into blast furnaces has thus far not met with industrial success.

It has now been found that, in spite of the above and under certain specific conditions, injected hydrogen can be an effective reducing agent in a process for producing molten iron from iron ore in an industrial furnace. More specifically, in accordance with the present invention, it has been found that, under certain specific conditions, injected hydrogen can be an effective iron-ore reducing agent in processes whereby the furnace is charged with iron ore and coke, whereby off-gas from the furnace is decarbonated and whereby at least a significant part of the decarbonated off-gas is recycled back to the furnace.

The present invention relates more specifically to a method of operating an iron- or steelmaking plant comprising an ironmaking furnace set which consists of one or more furnaces in which iron ore is transformed into liquid hot metal by means of a process which includes iron ore reduction, melting and off-gas generation, Said iron- or steelmaking plant optionally also comprises a converter downstream of the ironmaking furnace set.

A method of this type was developed during the European ULCOS (Ultra Low CO₂ Steelmaking) research project funded by the European Commission and is commonly referred to as the “top gas recycling blast furnace” or “TGRBF”.

In a TGRBF, substantially all of the CO₂ is removed from the blast furnace gas (BFG), also known as top gas, and substantially all of the remaining decarbonated blast furnace gas is recycled and reinjected into the blast furnace.

In this manner, coke consumption and CO₂ emissions are reduced.

Furthermore, in TGRBFs, oxygen is used as the oxidizer for combustion instead of the conventional (non-TGRBF) blast air or oxygen-enriched blast air.

The validity of the TGRBF concept has been demonstrated in a pilot scale blast furnace.

The ULCOS project demonstrated that approximately 25% of the CO₂ emissions from the process could be avoided by recycling decarbonated BFG.

In order to achieve the targeted 50% reduction of CO₂ emissions, the CO₂ removed from the (BFG) of the TGRBF must be sequestered and reused or stored (for example underground). Given the limited demand for CO₂ and the overwhelming excess of CO₂ available, storage is the dominant currently feasible option. However, not only may the transport of the CO₂ to its storage location and the storage itself entail significant costs, due to technical and social reasons, there are also insufficient locations where storage of significant amounts of CO₂ is both geologically sound and legally permitted.

There therefore remains a need to find other methods to achieve further reductions of CO₂ emissions during iron production from iron ore while maintaining furnace productivity and product quality.

### SUMMARY

Thereto, the present invention provides a method of operating an iron- or steelmaking plant comprising an ironmaking furnace set (or IFS) which consists of one or more furnaces in which iron ore is transformed into liquid hot metal by means of a process which includes iron ore reduction, melting and off-gas generation.

The off-gas is also referred to in the art as “top gas” (TG) or as “blast furnace gas” (BFG) when the furnace or furnaces of the set is/are blast furnaces.

The iron- or steelmaking plant optionally also comprises a converter, and in particular a converter for converting the iron generated by the IFS into steel. The plant may also include other iron- or steelmaking equipment, such as a steel reheat furnace, an EAF, etc.

In accordance with the invention:

(a) the IFS is charged with iron ore and coke.

(b) oxidizing gas is injected into the IFS. The oxidizing gas is also referred to in the art as “blast” when the furnace or furnaces of the set is/are blast furnaces.

(c) the generated off-gas is decarbonated downstream of the IFS. A CO₂-enriched tail gas stream and a decarbonated off-gas stream are thereby obtained. According to the present invention, the decarbonated off-gas stream contains not more than 10% vol CO₂. Decarbonation of the generated off-gas is preferably conducted so that the decarbonated off-gas stream contains not more than 3% vol CO₂.

(d) at least part of the decarbonated off-gas stream is injected back into the IFS as a reducing gas recycle stream. According to the present invention, at least 50% of the decarbonated off-gas stream is thus injected back into the IFS.

In addition, in accordance with the present invention:

(e) hydrogen and oxygen are generated by means of water decomposition,

(f) at least part of the thus generated hydrogen is injected into the ironmaking furnace set.

(g) at least part of the generated oxygen is also injected as oxidizing gas into the ironmaking furnace set and/or the converter, if present.

Preferably, all or part of the generated hydrogen which is injected into the ironmaking furnace set is mixed with the reducing gas recycle stream before the gas mixture of recycled reducing gas and generated hydrogen so obtained is injected into the ironmaking furnace set.

By means of the invention, reliance on coke and other hydrocarbon-based fuels is reduced as well as the CO₂ emissions per tonne of hot iron produced.

It will be appreciated that “injection into the IFS” means injection into the one or more furnaces of which the IFS consists.

The method according to the present invention thus uses a non-carbon-based hydrogen source for the optimization of the operation of the IFS by means of hydrogen injection, thereby reducing the CO₂ emissions of the IFS. In addition, the same non-carbon-based hydrogen source also generates oxygen which is likewise used to optimize the operation of the IFS and/or of other steelmaking equipment in the plant, such as a converter. The combined use of the generated hydrogen and the generated oxygen significantly reduces the costs associated with hydrogen injection into the IFS. In addition, by using water decomposition as the hydrogen source, no waste products are generated, which again reduces the costs of waste disposal.

The reducing stream can be injected into the IFS by means of tuyeres. In the case of blast furnace(s) said reducing stream can more specifically be injected via hearth tuyeres, and optionally also via shaft tuyeres.

As indicated above, the IFS can include or consist of one or more blast furnaces. In that case at least part or all of the oxidizing gas injected into the blast furnace(s) is injected in the form of blast, preferably in the form of hot blast.

When only part of the oxidizing gas injected into the IFS in step (b) consists of generated oxygen, i.e. when the oxidizing gas injected into the IFS consists in part of oxygen generated in step (e) and in part of oxygen-containing gas from a different source, whereby said oxygen-containing gas may in particular be air, oxygen or oxygen-enriched air, the oxygen generated in step (e) may be injected into the IFS:
separately from said oxygen-containing gas,
mixed with said oxygen-containing gas or
partially separately from the oxygen-containing gas and partially mixed with said oxygen-containing gas.

Thus, in the case of one or more blast furnaces, the blast, preferably hot blast, which is injected into the blast furnace in step (b) may advantageously comprises at least part or even all of the oxygen generated in step (e).

Likewise, when the plant includes a converter, the oxidizing gas injected into the converter for decarburizing a metal melt usefully consists at least in part or entirely of the oxygen generated in step (e).

The oxidizing gas injected into the IFS in step (b) is preferably substantially free of inert gases such as N₂. The oxidizing gas advantageously contains less than 20% vol, more preferably less than 10% vol and even more preferably at most 5% vol N₂, In addition, the oxidizing gas advantageously contains at least 70% vol, more preferably at least 80% vol and even more preferably at least 90% vol and up to 100% vol O₂.

During water decomposition, separate streams of oxygen and hydrogen are normally generated. No additional separation steps are therefore required after step (e) for separation of the generated oxygen from the generated hydrogen before mixing at least part of the generated hydrogen with the reducing gas recycle stream in step (f), respectively before the injection of at least part of the generated oxygen into the blast furnace and/or the converter in step (g) of the method according to the invention. In addition, the oxygen and hydrogen streams are generally high-purity streams, containing typically at least 80% vol, preferably at least 90% vol and more preferably at least 95% vol and up to 100% vol 02, respectively H₂.

Methods of water decomposition suitable for hydrogen and oxygen generation in step (e) include biological and/or electrolytic water decomposition.

A known form of biological water decomposition is photolytic biological (or photobiological) water decomposition, whereby microorganisms—such as green microalgae or cyanobacteria—use sunlight to split water into oxygen and hydrogen ions. At present, electrolytic water decomposition methods are preferred, as the technology is well-established and suited for the production of large amounts of hydrogen and oxygen.

As is known in the art, an electrolyte is advantageously added to the water in order to promote electrolytic water decomposition. Examples of such electrolytes are sodium and lithium cations, sulfuric acid, potassium hydroxide and sodium hydroxide.

Different types of water electrolysis, which are known in the art, may be used for the hydrogen and oxygen generation during step (e). These include:
alkaline water electrolysis, whereby water electrolysis takes place in an alkaline water solution,
high-pressure water electrolysis, including ultrahigh-pressure water electrolysis, whereby water electrolysis takes place at pressures above atmospheric pressure, typically from 5 to 75 MPa, preferably from 30 to 72 MPa for ultrahigh-pressure water electrolysis and from 10 to 25 MPa for high-pressure (but not ultrahigh-pressure) water electrolysis. An important advantage of high-pressure electrolysis is that the additional energy required for operating the water electrolysis is less than the energy that would be required for pressurizing the hydrogen and/or the oxygen generated by ambient pressure water electrolysis to the same pressures. If the pressure at which the hydrogen or oxygen is generated exceeds the pressure at which the gas is to be used, it is always possible to depressurize the generated gas to the desired pressure, for example in an expander.
High-temperature water electrolysis, whereby water electrolysis takes place at temperatures above ambient temperature, typically at 50° C. to 1100° C., preferably at 75° C. to 1000° C. and more preferably at 100° C. to 850° C. High-temperature water electrolysis is generally more energy efficient than ambient temperature water electrolysis. In addition, for applications whereby hydrogen or oxygen is used or preferably used at temperatures above ambient temperature, as is often the case for applications in the iron or steel industry, such as when hydrogen and or oxygen is injected into a blast furnace or when oxygen is injected into a converter, no or less energy is required to bring the gas to the desired temperature.
Polymer-electrolyte-membrane water electrolysis, which was first introduced by General Electric and whereby a solid polymer electrolyte is responsible for the conduction of protons, the separation of hydrogen and oxygen and the electrical insulation of the electrodes.

Combinations of said water electrolysis techniques are also possible.

Thus, whereas in step (e) the water electrolysis may take place at ambient pressure, high-pressure water electrolysis may also be used to generate hydrogen and/or oxygen at a pressure substantially above ambient pressure, e.g. at pressures from 5 to 75 MPa, in particular from 30 to 72 MPa or from 10 to 25 MPa.

Whereas in step (e) the water electrolysis may be conducted at ambient temperature, high-temperature water electrolysis generating hydrogen and/or oxygen at temperatures from 50° C. to 1100° C., preferably from 75° C. to 1000° C. and more preferably from 100° C. to 850° C. may advantageously also be used.

The electricity used for the water decomposition in step (e) is preferably obtained with a low carbon footprint, more preferably without generating CO₂ emissions, Examples of CO₂-free electricity generation include hydropower, solar power, wind power and tidal power generation, but also geothermic energy recovery and even nuclear energy.

The method advantageously also includes the step of:

(a) heating the reducing gas recycle stream or the mixture of generated hydrogen with the reducing gas recycle stream in hot stoves to a temperature between 700° C. and 1300° C., preferably between 850° C. and 1000° C. and more preferably between 880° C. and 920° C. upstream of the IFS.

In that case, the method preferably also includes the step of:

(b) producing a low-heating-value gaseous fuel with a heating value of from 2.8 to 7.0 MJ/Nm³ and preferably from 5.5 to 6.0 MJ/Nm³, which contains (i) at least a portion of the tail gas stream and (ii) a second part of the generated hydrogen, said low-heating-value gaseous fuel being used to heat the hot stoves.

At least part of the CO₂-enriched tail gas may be captured for sequestration and/or use in a further process. The iron- or steelmaking plant may include one or more storage reservoirs for the storage of the CO₂ separated off in step (c) of the method according to the invention prior to sequestration or further use.

The generated hydrogen and/or the mixture of generated hydrogen with the top-gas recycle stream are typically injected into the blast furnace(s) via hearth tuyeres, and optionally also via shaft tuyeres.

The oxidizing gas injected into the IFS is typically a high-oxygen oxidizing gas, i.e. an oxidizing gas having an oxygen content higher than the oxygen content of air and preferably a high-oxygen oxidizing gas as defined above. Air may nevertheless be used to burn the low heating-value gaseous fuel for heating the hot stoves.

Between 80 and 90% vol of the decarbonated off-gas stream or decarbonated blast furnace gas stream is preferably thus heated in the hot stoves and injected into the IFS.

For the decarbonation of the off-gas, respectively blast furnace gas, in step (c), a VPSA (Vacuum Pressure Swing Adsorption), a PSA (Pressure Swing Adsorption) or a chemical absorption unit, for example with use of amines, may be used.

The hydrogen generated in step (e) consists preferably for at least 70% vol of H₂ molecules, preferably for at least 80% vol and more preferably for at least 90% vol, and up to 100% vol. This can be readily achieved as the hydrogen generation process of step (e) does not rely on hydrocarbons as starting material.

According to a preferred embodiment, all of the oxygen injected into the IFS and/or converter consists of oxygen generated in step (e). Embodiments whereby all of the oxygen injected into the IFS consists of oxygen generated in step (e) are particularly useful.

However, oxygen from other sources, in particular from an Air Separation Unit (ASU) may also be injected into the IFS and/or into the converter (when present). For example, oxygen generated by ASUs using cryogenic distillation, Pressure Swing Adsorption (PSA) or Vacuum Swing Adsorption (VSA) may be injected into the IFS and/or into the converter. The iron- or steelmaking plant may include one or more reservoirs for storing oxygen until it is used in the plant.

Parts of the oxygen generated in step (e) of the method may also advantageously be used in other installations of the iron- or steelmaking plant, such as, for example, as oxidizing gas in an electric arc furnace (EAF) and/or in a continuous steel caster, when present, or in other installations/processes in the plant that require oxygen. Alternatively or in combination therewith, part of the generated oxygen not injected into the blast furnace or the converter may be sold to generate additional revenue.

Water decomposition generates hydrogen and oxygen at a hydrogen-to-oxygen ratio of 2 to 1.

In accordance with a preferred embodiment of the invention, all of the hydrogen injected into the IFS, other than the hydrogen present in the off-gas recycle stream, is hydrogen generated by water decomposition in step (e). Likewise, preferably all of the oxygen injected into the IFS and/or into the converter in step (g) is oxygen generated by water decomposition in step (e). Preferably, all of the hydrogen generated in step (e) which is injected into the IFS is mixed with the off-gas recycle stream before being injected into the ironmaking furnace set.

In other words, in these cases the water decomposition of step (e) can meet the entire oxygen requirement of the IFS, of the converter, respectively of the IFS and the converter.

According to a useful embodiment, the ratio between (i) the hydrogen generated in step (e) and injected into the IFS (i.e. excluding any hydrogen present in the off-gas recycle stream), and (ii) the oxygen generated in step (e) and injected into the IFS and/or the converter in step (g) (i.e. excluding oxygen from other sources, such as any oxygen present in air, such as blast air, that may also be injected into the IFS as oxidizing gas), is substantially equal to 2, i.e. between 1.50 and 2.50, preferably between 1.75 and 2.25, and more preferably between 1.85 and 2.15.

According to a specific advantageous embodiment, all of the oxygen injected into the IFS is oxygen generated by water decomposition in step (e) and the ratio between (i) the hydrogen generated in step (e) and injected into the IFS and (ii) the oxygen generated in step (e) and injected into the IFS in step (g) is substantially equal to 2, i.e. between 1.5 and 2.5, preferably between 1.75 and 2.25, more preferably between 1.85 and 2.15.

In such a case, reliance for said gas injections on external oxygen or hydrogen sources other than the water decomposition of step (e), can be substantially avoided. Nevertheless, the iron- or steelmaking plant may include one or more reservoirs for storing hydrogen for use in the plant, for example as a hydrogen back-up or to meet higher hydrogen demands at certain stages of the iron- or steelmaking process, such as when the demand for (hot) metal is higher.

When the ratio between (i) the generated hydrogen injected into the IFS and the generated oxygen injected into the IFS and/or converter is not substantially equal to 2, it may still be possible to arrive at an overall generated hydrogen-to-generated oxygen consumption ratio which is substantially equal to 2 by using any surplus of generated gas (which may be generated oxygen or generated hydrogen) in other installations or processes of the plant. Thus, in embodiments of the present invention whereby at least part or the generated hydrogen and/or at least part of the generated oxygen is used (consumed) in processes or installations of the iron- or steelmaking plant other than the IFS, respectively the IFS and/or the converter, the ratio between (i) the hydrogen generated in step (e) used in the plant and (ii) the oxygen generated in step (c) used in the plant can still usefully be substantially equal to 2, i.e. between 1.5 and 2.5, preferably between 1.75 and 2.25, more preferably between 1.85 and 2.15.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 schematically illustrates a prior art steelmaking plant, and

FIG. 2 schematically illustrates an embodiment of the invention.

### DETAILED DESCRIPTION OF PREFERRED EMBODIMENTS

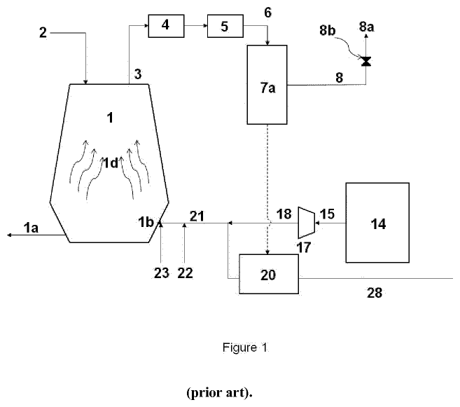

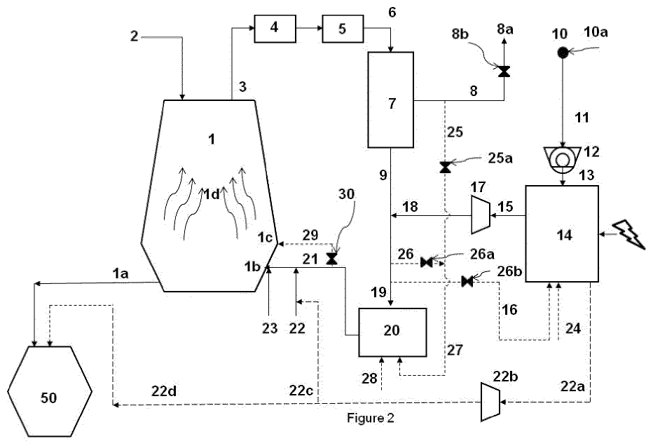

The present invention and its advantages are further clarified in the following example, reference being made to FIGS. 1 and 2, whereby FIG. 1 schematically illustrates a prior art steelmaking plant whereby the IFS consists of one or more non-TGRBFs (only one blast furnace is schematically represented and in the corresponding description reference is made to only one non-TGRBF) and FIG. 2 schematically illustrates an embodiment of the method according to the invention applied to a steelmaking plant whereby the IFS consists of one or more TGRBFs (only one TGRBF is represented and in the corresponding description reference is also made to only one TGRBF), whereby identical reference numbers are used to indicate identical or analogous features in the two figures.

FIG. 1 which shows a prior art conventional blast furnace 1 without top gas decarburization or recycling. Blast furnace 1 is charged from the top with coke and iron ore 2 which descend in the blast furnace 1.

Air 28 is preheated in hot stoves 20 before being injected into blast furnace 1 via hearth tuyeres 1b. Substantially pure oxygen 22 can be added to blast air 28 via the hearth tuyeres 1b or upstream of the hot stoves 20.

Pulverized coal (or another organic combustible substance) 23 is typically also injected into the blast furnace 1 by means of hearth tuyeres 1b.

The air 28, and, if added, the substantially pure oxygen 22 and the pulverized coal (or another organic fuel) 23 combine inside the blast furnace so as to produce heat by combustion and reducing gas 1d (in contact with the coke present in solid charge 2). Reducing gas 1d ascends the inside of blast furnace 1 and reduces the iron oxides contained in the ore to metallic iron. This metallic iron continues its descent to the bottom of the blast furnace 1 where it is removed (tapped) la along with a slag containing oxide impurities.

The off-gas, better known as blast furnace gas (BFG), 3 exits the blast furnace 1 and travels to an initial dust removal unit 4 where large particles of dust are removed. It continues to a second dust removal system 5 that removes the fine dust particles to produce a “clean gas” 6. The clean gas 6 is optionally dewatered before entering the BFG distribution system 7a where part of the clean gas 6 can be sent distributed to the hot stoves 20, where it is used as a fuel, and part 8 of the clean gas 6 can be sent to other locations 8a of the steel plant for various uses. The flow of BFG to the one or more other locations 8a is controlled by control valve system 8b.

Hydrogen, CO or a mixture of hydrogen and CO may be also be injected into the blast furnace 1 via hearth tuyere 1b as additional reducing gas. (A single tuyere is schematically represented in the figure, whereas in practice, a blast furnace comprises a multitude of tuyeres)

In order to limit the carbon footprint of the known blast furnace operation, the hydrogen, CO or the mixture of hydrogen and CO can be sourced from environmentally friendly sources, such as biofuel partial combustion or reforming.

As indicated earlier, in order to limit CO₂ emissions by the blast furnace, hydrogen could appear to be the preferred additional reducing gas. Unfortunately, the cost of substantially pure hydrogen gas is usually inhibitive for this kind of industrial application.

A further technical problem related to hydrogen (and CO) injection into a blast furnace relates to the thermodynamics of the blast furnace process, namely the fact that the efficiency of hydrogen (and CO) usage in the blast furnace rarely exceeds 50%, 50% of the hydrogen injected in the blast furnace thus exits the top of the blast furnace without participating in the reactions. This limits the use of hydrogen in a conventional blast furnace.

Table 1 presents a theoretical comparison, based on process simulation, between operations of a conventional blast furnace injecting 130, 261 and 362 Nm³ hydrogen/tonne hot metal (thm) into a standard blast furnace with powdered coal injection (PCI) when that hydrogen is used to replace coal while keeping the coke rate constant. Also presented in Table 1 are the cases when 130 and 197 Nm3 of hydrogen are replacing coke while keeping the coal injection (PCI) rate constant.

TABLE 1

| | | | 11.72 Kg H2 | 11.72 Kg H2 | 17.7 Kg H2 | 2 [symbol] .44 Kg H2 | [symbol] .61 Kg H2 |
|---|---|---|---|---|---|---|---|
| Period (Enter the name | | Reference | Replacing | Replacing | Replacing | Replacing | Replacing |
| of the period) | Units | Final | Coal | Coke | Coke | Coal | Coal |
| Reductant Consumption | | | | | | | |
| Coke rate (small + big) | Kg/ [symbol] | 293 | 293 | 2 [symbol] 5 | 2 [symbol] 3 | 293 | 293 |
| Fuel Injection Rate | Kg/ [symbol] | 197 | 179 | 209 | 215 | 164 | 1 [symbol] 3 |
| Coal Injection Rate | Kg/ [symbol] | 197 | 167 | 197 | 197 | 141 | 120 |
| Hydrogen Injection Rate | Kg/ [symbol] | 0 | 11.72 | 11.72 | 17.70 | 23.44 | 32.61 |
| Hydrogen Injection Rate | N [symbol] | 0 | 130 | 130 | 197 | 281 | [symbol] 62 |
| Total Fuel Rate | Kg/ [symbol] | 490 | 471 | 474 | 4 [symbol] | 457 | 445 |
| Tuyeres | | | | | | | |
| Blast Volume (Air Only) | N [symbol] | [symbol] 32 | [symbol] 2 [symbol] | [symbol] 27 | [symbol] 1 [symbol] | 814 | 801 |
| Blast Temperature | ° C. | 117 [symbol] | 117 [symbol] | 117 [symbol] | 117 [symbol] | 117 [symbol] | 117 [symbol] |
| Oxygen Volume Calculated | N [symbol] | 82.0 | 76. [symbol] | 79.7 | [symbol] 0.4 | 75.7 | 75.1 |
| Oxygen in the cold blast | % | 27. [symbol] % | 27.2% | 27.4% | 27. [symbol] % | 27.2% | 27.2% |
| Water Vapour added to Blast | g/Nm [symbol] | 12.23 | [symbol] .00 | 5.00 | 5.00 | 5.00 | [symbol] .00 |
| Raceway Gas Volume | N [symbol] | 1 [symbol] 11 | 13 [symbol] | 1413 | 147 [symbol] | 149 [symbol] | 16573 |
| (Bosh Gas Volume) | | | | | | | |
| Bosh Reducing Gas | N [symbol] | [symbol] 33 | 723 | 739 | [symbol] 03 | 8 [symbol] | 920 |
| (CO [symbol] 2) Volume | | | | | | | |
| RAFT (Raceway Adiabatic | ° C. | 2251 | 2124 | 20 [symbol] 9 | 200 [symbol] | 1992 | 1901 |
| Flame Temp.) | | | | | | | |
| Top Gas | | | | | | | |
| Volume (dry) | N [symbol] | 1441 | 1453 | 145 [symbol] | 146 [symbol] | 14 [symbol] | 1477 |
| Temperature | ° C. | 12 [symbol] | 154 | 17 [symbol] | 200 | 181 | 200 |
| CO | % | 24.5 | 22. [symbol] 6 | 22. [symbol] | 21.7 | 20.9 | 19.7 |
| CO2 | % | 24.1 | 22.4 | 22.3 | 21.5 | 20.9 | 19.6 |
| H2 | % | 4.3 | 8.5 | 8.9 | 11.4 | 13. [symbol] | 1 [symbol] .5 |
| N2 | % | 47.1 | 46.4 | 4 [symbol] .2 | 45.4 | 45.2 | 44.2 |
| CO2/(CO + CO2) | | 0.4 [symbol] | 0.499 | 0.497 | 0.497 | 0.49 [symbol] | 0.499 |
| BF Operational Results | | | | | | | |
| Gas Utilization at FeO Level | % | 93.0 | 93.0 | 93.0 | 93.0 | 9 [symbol] .0 | 9 [symbol] .0 |
| Calculated Heat Lo [symbol] | M [symbol] | 40 [symbol] .7 | 40 [symbol] .7 | 40 [symbol] .7 | 40 [symbol] .7 | 40 [symbol] .7 | 40 [symbol] .7 |
| % of Heat Losses in the Lower BF | % | [symbol] 0.7 | [symbol] 0.7 | [symbol] 0.7 | [symbol] 0.7 | [symbol] 0.7 | [symbol] 0.7 |
| Global Direct Reduction Rate | % | 30. [symbol] % | 26.1% | 2 [symbol] .4% | 22.2% | 20. [symbol] % | 1 [symbol] .2% |
| Direct Reduction Degree of | % | 2 [symbol] .7% | 24.9% | 24.1% | 20.9% | 19.2% | 14.8% |
| Iron Oxides | | | | | | | |
| Reduction of CO2 Emission (per tonne HM) | | | | | | | |
| Carbon Consumption | Kg/ [symbol] | 423 | 398 | 399 | 388 | 376 | 359 |
| CO2 Emissions | Kg/ [symbol] | 1590 | 14 [symbol] 9 | 1461 | 1421 | 1378 | 1315 |
| CO2 Savings | Kg/ [symbol] | — | 92 | 89 | 130 | 172 | 235 |
| % CO2 Savings | Kg/ [symbol] | — | 5.9% | 5.7% | 8.4% | 11.1% | 15.2% |
| Relative Production Rate | Kg/ [symbol] | 100% | 100.0% | 100.0% | 100.0% | 100.0% | 100.0% |
| CO2 for electricity @ [symbol] 00 g CO2/kWh | [symbol] / [symbol] | 24.0 | 24.0 | 24.0 | 24.0 | 24.0 | 24.0 |
| (not including oxygen) | | | | | | | |
| O2 for electricity @ [symbol] 00 g CO2/kWh | [symbol] / [symbol] | 27.1 | 25. [symbol] | 26.3 | 2 [symbol] .5 | 25.0 | 24.8 |
| (oxygen) | | | | | | | |
| Total CO2 saved | [symbol] / [symbol] | 0 | 9 [symbol] | 90 | 130 | 174 | 237 |
| % CO2 saved | % | — | 5.8% | 5. [symbol] | 8.1% | 10.9% | 14.8% |
| Hydrogen to Oxygen Ratio | | | 1.7 | 1.64 | 2.45 | 3.44 | 4.83 |

[symbol]

indicates data missing or illegible when filed

TABLE 2

| | | | | ULCOS | ULCOS | ULCOS |
|---|---|---|---|---|---|---|
| | | | | Version 4, | Version 4, | Version 4, |
| | | | ULCOS | 50% recycle | 50% recycle | 50% recycle |
| | | | Version 4, | gas in belly | gas in belly | gas in belly |
| Period (Enter the name | | Reference | 10% recycle | 130 Nm3 | 260 Nm3 | 350 Nm3 |
| of the period) | Units | Final | gas in belly | H2/thm | H2/thm | H2/thm |
| Reductant Consumption | | | | | | |
| Coke rate (Small + big) | Kg/thm | 293 | 359 | 320 | 255 | 230 |
| Fuel Injection Rate | Kg/thm | 197 | 23 | 0 | 0 | 0 |
| Coal Injection Rate | Kg/thm | 197 | 23 | 0 | 0 | 0 |
| Hydrogen Injection Rate | Kg/thm | 0 | 0.00 | 11.73 | 23.45 | 31.5 [symbol] |
| Hydrogen Injection Rate | Nm3/thm | 0 | 0 | 130 | 2 [symbol] 0 | 350 |
| Total Fuel Rate | Kg/thm | 4 [symbol] 0 | 382 | 332 | 279 | 2 [symbol] 2 |
| Tuyeres | | | | | | |
| Blast Volume (Air Only) | Nm3/thm | 832 | 0 | 0 | 0 | 0 |
| Blast Temperature | ° C. | 117 [symbol] | — | — | — | — |
| Oxygen Volume Calculated | Nm3/thm | 82.0 | 218.1 | 192.8 | 161.3 | 149.4 |
| Oxygen in the cold blast | % | 27. [symbol] % | 100.0% | 100.0% | 100.0% | 100.0% |
| Water Vapour added to Blast | g/Nm3 | 12.23 | 0.00 | 0.00 | 0.00 | 0.00 |
| Raceway Gas Volume | Nm3/thm | 1311 | 1271 | 973 | 991 | 939 |
| (Bosh Gas Volume) | | | | | | |
| RAFT (Raceway Adiabatic | ° C. | 2251 | 1901 | 2078 | 1900 | 1900 |
| Flame Temp.) | | | | | | |
| Top Gas | | | | | | |
| Volume (dry) | Nm3/thm | 1441 | 13 [symbol] 7 | 1401 | 1339 | 1188 |
| Temperature | ° C. | 128 | 200 | 200 | 17 [symbol] | 101 |
| CO | % | 24.5 | 51.2 | 42.2 | 32.0 | 28.5 |
| CO2 | % | 24.1 | 3 [symbol] .3 | 2 [symbol] .7 | 24.2 | 23.1 |
| H2 | % | 4.3 | 2. [symbol] | 13.1 | 2 [symbol] .1 | 3 [symbol] .1 |
| N2 | % | 47.1 | 11.0 | 14.9 | 17.8 | 12.3 |
| CO2/(CO + CO2) | | 0.4 [symbol] | 0.408 | 0.413 | 0.430 | 0.448 |
| BF Operational Results | | | | | | |
| Gas Utilization at FeO Level | % | [symbol] 3.0 | [symbol] 3.0 | [symbol] 3.0 | [symbol] 3.0 | [symbol] 3.0 |
| Calculated Heat Looses | M [symbol] /thm | 108.7 | 408.7 | 408.7 | 40 [symbol] .7 | 408.7 |
| % of Heat Losses in the Lower BF | % | 80.7 | 80.7 | 80.7 | [symbol] 0.7 | 80.7 |
| Global Direct Reduction Rate | % | 30.8% | 10.4% | 5.8% | 0.0% | 0.0% |
| Direct Reduction Degree of | % | 29.7% | 8.8% | 4.2% | 0.0% | 0.0% |
| Iron Oxides | | | | | | |
| Reduction of CO2 Emission (per tonne HM) | | | | | | |
| Carbon Consumption | Kg/thm | 423 | 337 | 2 [symbol] 4 | 224 | 204 |
| CO2 Emissions | Kg/thm | 1550 | 1236 | 1042 | [symbol] 22 | 749 |
| CO2 Savings | Kg/thm | — | 314 | 509 | 72 [symbol] | 801 |
| % CO2 Savings | Kg/thm | — | 20.3% | 32.8% | 47.0% | 51.7% |
| Relative Production Rate | Kg/thm | 100% | 100.0% | 101.9% | 120.9% | 145.3% |
| CO2 for electricity @ [symbol] 00 g CO2/kWh | kg/thm | 24.0 | 24.0 | 23. [symbol] | 19.9 | 1 [symbol] .5 |
| (not including oxygen) | | | | | | |
| O2 for electricity @ [symbol] 00 g CO2/kWh | kg/thm | 27.1 | 72.0 | [symbol] 3. [symbol] | 53.2 | 49.3 |
| (oxygen) | | | | | | |
| Total CO2 saved | kg/thm | 0 | 269 | 473 | 70 [symbol] | 787 |
| % CO2 saved | % | — | 16.8% | 29.5% | 41.1% | 49.1% |
| Hydrogen to Oxygen Ratio | | | 0.00 | 0.67 | 1.61 | 2.34 |

[symbol]

indicates data missing or illegible when filed

TABLE 3

| | | | | | | Total CO2 | | |
|---|---|---|---|---|---|---|---|---|
| | Iron | | | Oxygen Volume | | saved with | | Additional |
| | Production | Coke Charge | Coal Injection | Required in | CO2 | respect to | % CO2 | Hydrogen |
| | Rate | rate | Rate | Blast Furnace | Produced | conventional BF | saved | Injected |
| Units | tonne/d | Kg/thm | Kg/thm | Nm3/thm | kg/thm | tonnes/year | % | Nm3/h |
| Reference | 5784 | 293 | 146 | 92.2 | 1510 | — | — | — |
| Conventional w. PCI | 5784 | 300 | 189 | 58.1 | 1550 | — | — | — |
| Conventional w. NG | 5784 | 303 | 0 | 173.4 | 1402 | 308971 | 9.8% | — |
| Conventional 100 Nm3 H2/thm | 5784 | 270 | 189 | 63.7 | 1467 | 242922 | 7.7% | 24098 |
| Conventional 200 Nm3 H2/thm | 5784 | 240 | 189 | 69.8 | 1385 | 483163 | 15.4% | 48197 |
| Conventional 300 Nm3 H2/thm | 5784 | 210 | 189 | 74.9 | 1259 | 814611 | 26.0% | 72295 |
| ULCCS Version 4 | 6383 | 209 | 190 | 239.6 | 1258 | 903884 | 26.1% | — |
| ULCOS 100 Nm3/t H2 injection | 7019 | 185 | 190 | 227.5 | 1180 | 1258836 | 33.1% | 29246 |
| ULCOS 100 Nm3/t H2 injection | 6344 | 263 | 74 | 203.9 | 1082 | 1138784 | 33.1% | 26432 |
| 74 Kg/thm PCI | | | | | | | | |
| ULCOS 200 Nm3/t H2 injection | 7506 | 169 | 190 | 219.3 | 1127 | 1539163 | 37.8% | 62546 |
| ULCOS 200 Nm3/t H2 injection | 6812 | 291 | 1 | 177.4 | 947 | 1463335 | 39.6% | 56764 |
| No PCI | | | | | | | | |
| ULCOS 300 Nm3/t H2 injection | 7866 | 170 | 164 | 206.0 | 1053 | 1810700 | 42.4% | 98319 |
| ULCOS 300 Nm3/t H2 injection | 7526 | 258 | 1 | 160.6 | 840 | 2006584 | 49.2% | 94071 |
| No PCI | | | | | | | | |
| ULCOS 400 Nm3/t H2 injection | 8197 | 167 | 151 | 197.2 | 1003 | 2041574 | 45.9% | 136624 |
| w 151 Kg PCI | | | | | | | | |
| ULCOS 400 Nm3/t H2 injection | 8188 | 195 | 94 | 180.0 | 920 | 2176259 | 49.0% | 136472 |
| w 94 Kg PCI | | | | | | | | |

| | | Total Oxygen | | | | |
|---|---|---|---|---|---|---|
| | | Requirements | | Total Oxygen | Additional | Additional |
| | | (80% Hot Metal, | | requirement | Oxygen | Oxygen |
| | Additional Hydrogen | 20% Scrap, 93% yield) | | for Blast | Surplus/Deficit | Surplus/Deficit |
| | produced/Additional | Blast | L-D Converter | Furnace and | (−) from Water | (−) from Water |
| | Oxygen required | Furnace | (55 Nm3/thm) | L-D Converter | Decomposition | Decomposition |
| Units | H2/O2 Ratio | Nm3/h | Nm3/h | tonnes/day | NmS/h | tonnes/day |
| Reference | — | 22211 | 15408 | 1289 | | |
| Conventional w. PCI | — | 13996 | 15408 | 1008 | — | — |
| Conventional w. NG | — | 41791 | 15408 | 1960 | — | — |
| Conventional 100 Nm3 H2/thm | 1.57 | 15348 | 15408 | 1054 | −18707 | −641 |
| Conventional 200 Nm3 H2/thm | 2.87 | 16816 | 15408 | 1104 | −8125 | −278 |
| Conventional 300 Nm3 H2/thm | 4.01 | 18050 | 15408 | 1147 | 2690 | 92 |
| ULCCS Version 4 | — | 63714 | 17004 | 2766 | — | — |
| ULCOS 100 Nm3/t H2 injection | 0.44 | 66532 | 18699 | 2921 | −70608 | −2420 |
| ULCOS 100 Nm3/t H2 injection | 0.49 | 53894 | 16900 | 2426 | −57578 | −1973 |
| 74 Kg/thm PCI | | | | | | |
| ULCOS 200 Nm3/t H2 injection | 0.91 | 68582 | 19995 | 3036 | −57304 | −1964 |
| ULCOS 200 Nm3/t H2 injection | 1.13 | 50347 | 18147 | 2347 | −40112 | −1375 |
| No PCI | | | | | | |
| ULCOS 300 Nm3/t H2 injection | 1.46 | 67516 | 20954 | 3032 | −39310 | −1347 |
| ULCOS 300 Nm3/t H2 injection | 1.87 | 50347 | 20049 | 2412 | −23360 | −801 |
| No PCI | | | | | | |
| ULCOS 400 Nm3/t H2 injection | 2.03 | 67352 | 21838 | 3057 | −20879 | −716 |
| w 151 Kg PCI | | | | | | |
| ULCOS 400 Nm3/t H2 injection | 2.22 | 61406 | 21814 | 2852 | −14984 | −514 |
| w 94 Kg PCI | | | | | | |

Table 3 demonstrates the reduced requirement for external oxygen at the blast furnace and at the L-D Converter as illustrated in FIG. 2 when oxygen from the water decomposition process is used in the steelmaking plant.

As shown in Table 3, if oxygen from the water decomposition process is used for the blast furnace and the L-D converter, the need for external oxygen, typically from an air separation plant, to meet the oxygen requirement of the steel plant is greatly reduced or non-existent.

For most of the embodiments illustrated in Table 3, the use of water decomposition to meet the entire requirement of the blast furnace for additional hydrogen results in a generation of oxygen which is insufficient to meet the (additional) oxygen requirement of the blast furnace and the converter. Consequently, additional oxygen must be obtained from a further oxygen source, such as an ASU, in order to meet said requirement. However, the amount of oxygen to be obtained from said further oxygen source is drastically reduced.

However, when the use of water decomposition to meet the entire requirement of the blast furnace and/or for the converter (if present) results in the generation of oxygen in excess of the additional oxygen requirement of the blast furnace (and, if applicable, the converter), surplus generated oxygen may advantageously be used in other processes/installations of the iron- or steelmaking plant and/or be sold to generate revenue. The present invention thus provides a method for reducing CO₂ emissions from an iron- or steelmaking plant comprising an iron furnace set (IFS) by means of the injection into the IFS of a non-carbon-based reducing agent and this at lower overall cost. It also greatly reduces the amount of external oxygen produced by ASU, VSA, VPSA or any other method to complete the oxygen requirement of the iron- or steelmaking plant. In doing this the amount of indirect CO₂ emissions from oxygen production are also avoided or reduced. The carbon footprint of the iron- or steelmaking plant can be further reduced by using low-carbon-footprint electricity as described above.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A method of operating an ironmaking or steelmaking plant comprising an ironmaking furnace set comprising one or more furnaces in which iron ore is transformed into liquid hot metal by means of a process which includes iron ore reduction, melting and off-gas generation, the ironmaking or steelmaking plant, the method comprising the steps of:
a. charging the ironmaking furnace set with iron ore and coke,
b. injecting oxidizing gas into the ironmaking furnace set,
c. producing an off-gas and decarbonating the off-gas downstream of the ironmaking furnace set thereby obtaining a CO₂-enriched tail gas stream and a decarbonated off-gas stream containing not more than 10% vol CO₂,
d. injecting at least 50% of the decarbonated off-gas stream back into the ironmaking furnace set as a reducing gas recycle stream,
e. generating hydrogen and oxygen by means of water decomposition,
f. injecting at least part of the hydrogen generated in step into the ironmaking furnace set, and
g. injecting at least part of the generated oxygen into the ironmaking furnace set and/or the converter as oxidizing gas.

17. The method according to claim 16, whereby at least part of the hydrogen generated in step (e) which is injected into the ironmaking furnace set is mixed with the reducing gas recycle stream before the gas mixture so obtained is injected into the ironmaking furnace set.

18. The method according to claim 16, wherein:
h. the gas recycle stream or the mixture of hydrogen generated in step (e) with the gas recycle stream is heated upstream of the ironmaking furnace set to a temperature between 700° C. and 1300° C.

19. The method according to claim 18, wherein:
i. a low-heating-value gaseous fuel having a heating value of from 2.8 to 7.0 MJ/Nm³ is produced containing (i) at least a portion of the tail gas stream and (ii) a second part of the hydrogen generated in step (e), said low-heating-value gaseous fuel being used to heat the hot stoves used for heating the gas recycle stream.

20. The method according to claim 16, whereby the ratio between:
(i) the hydrogen generated in step (e) and injected into the ironmaking furnace set and
(ii) the oxygen generated in step (e) and injected into the ironmaking furnace set and/or the converter in step (g) is between 1.50 and 2.50.

21. The method according to claim 16, whereby the ratio between:
(i) the hydrogen generated in step (e) and injected into the ironmaking furnace set and
(ii) the oxygen generated in step (e) and injected into the ironmaking furnace set in step (g)
is between 1.75 and 2.25.

22. The method according to claim 16, wherein pulverized coal and/or another organic combustible substance is injected into the blast furnace by means of tuyeres.

23. The method according to claim 16, wherein all or part of the generated hydrogen which is injected into the ironmaking furnace set is injected into the ironmaking furnace set via tuyeres.

24. The method according to claim 16, wherein all or part of the oxygen generated in step (e) is mixed with oxygen-containing gas not generated in step (e) so as to obtain a mixture which is injected as oxidizing gas into the ironmaking furnace set.

25. The method according to claim 16, wherein the oxidizing gas which is injected into the ironmaking furnace set in step (b) consists of oxygen generated in step (e).

26. The method according to claim 16, wherein in step (e), hydrogen and oxygen are generated by biological and/or electrolytic water decomposition.

27. The method of claim 26, wherein in step (e), hydrogen and oxygen are generated by electrolytic water decomposition at a pressure above atmospheric pressure and/or at a temperature above ambient temperature.

28. The method according to claim 16, wherein the reducing gas is injected into the ironmaking furnace set via tuyeres.

29. The method according to claim 16, wherein the ironmaking furnace set comprises one or more blast furnaces.

30. The method according to claim 16, wherein the hydrogen generated in step (e) consists for at least 70% vol of H₂ molecules.
